(19) United States
(12) Patent Application Publication
(10) Pub. No.: US 2007/0043646 A1
(43) Pub. Date: Feb. 22, 2007

(54) METHODS, SYSTEMS, AND COMPUTER PROGRAM PRODUCTS FOR CONDUCTING A BUSINESS TRANSACTION USING A PUB/SUB PROTOCOL

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/161,899

(22) Filed: Aug. 22, 2005

(51) Int. Cl. G06Q 40/00

(52) U.S. Cl. 705/37

(57) ABSTRACT

Methods, systems, and computer program products are disclosed for conducting a business transaction using a pub/sub protocol. Information about at least one of a sale or auction is received. The information is provided and updated using a pub/sub protocol. A request to take part in the sale/auction is sent and a response to the request is received. A business transaction may also be facilitated using a pub/sub protocol by receiving a request for information about at least one of a sale or auction from a remote endpoint and providing the requested information to the remote endpoint. Updated information is provided to the remote endpoint using a pub/sub protocol.

### RELATED APPLICATIONS

The present application is related to co-pending U.S. patent application Ser. No. 11/160,612, entitled “METHOD AND APPARATUS FOR BROWSING NETWORK RESOURCES USING AN ASYNCHRONOUS COMMUNICATIONS PROTOCOL,” filed on Jun. 30, 2005, and assigned to the assignee of the present application. The present application is also related to co-pending U.S. patent application Ser. No. 11/160,157, entitled “METHOD, SYSTEM, AND DATA STRUCTURE FOR PROVIDING A GENERAL REQUEST/RESPONSE MESSAGING PROTOCOL USING A PRESENCE PROTOCOL,” filed on Jun. 10, 2005, and assigned to the assignee of the present application. The present application is also related to co-pending U.S. patent application Ser. No. 11/118,882 entitled “SYSTEM AND METHOD FOR UTILIZING A PRESENCE SERVICE TO ADVERTISE ACTIVITY AVAILABILITY,” filed on Apr. 29, 2005, and assigned to the assignee of the present application. The present application is also related to co-pending U.S. patent application Ser. No. 11/096,764, entitled “SYSTEM AND METHOD FOR UTILIZING A PRESENCE SERVICE TO FACILITATE ACCESS TO A SERVICE OR APPLICATION OVER A NETWORK,” filed on Mar. 31, 2005, and assigned to the assignee of the present application. The present application is also related to co-pending U.S. patent application Ser. No. 10/960,365, entitled “SYSTEM AND METHOD FOR UTILIZING CONTACT INFORMATION, PRESENCE INFORMATION AND DEVICE ACTIVITY,” and co-pending U.S. patent application Ser. No. 10/960,135, entitled “SYSTEM AND METHOD FOR UTILIZING CONTACT INFORMATION, PRESENCE INFORMATION AND DEVICE ACTIVITY,” both filed on Oct. 6, 2004, and both assigned to the assignee of the present application. The present application is also related to co-pending U.S. patent application Ser. No. 10/900,558, entitled “SYSTEM AND METHOD FOR PROVIDING AND UTILIZING PRESENCE INFORMATION,” filed on Jul. 28, 2004, and assigned to the assignee of the present application. The present application is also related to co-pending U.S. patent application Ser. No. 10/903,576, entitled “SYSTEM AND METHOD FOR HARMONIZING CHANGES IN USER ACTIVITIES, DEVICE CAPABILITES AND PRESENCE INFORMATION,” filed on Jul. 30, 2004, and assigned to the assignee of the present application. Each of the above-cited related applications is incorporated here by reference in its entirety.

### TECHNICAL FIELD

The subject matter described herein relates to communication protocols. More particularly, the subject matter described herein relates to conducting a business transaction using a pub/sub protocol.

### BACKGROUND

Conducting online business transactions, such as the buying and selling of items or services at a fixed priced or through an auction, are traditionally done through centralized sites such as EBAY, AMAZON, etc., using a browser. Today's more popular browsers, such as MICROSOFT'S INTERNET EXPLORER and MOZILLA FOUNDATION'S FIREFOX, use synchronous communications protocols, such as the HyperText Transport Protocol (HTTP), to exchange information over the Internet. With a synchronous communications protocol, one entity in a network (e.g., the browser) sends a request to another network entity (e.g., a web server), then waits for a reply before sending additional requests.

Synchronous communications protocols work well for supporting certain browsing tasks, such as when the browser sends a request to the web server for a web page, and then waits for a reply from the server to display the requested page. Other browsing tasks, however, are not carried out as efficiently using synchronous communications protocols. For example, during an online sale, original or updated information about an item or service of interest may need to be provided to a client. It would be advantageous to provide this information in near real-time instead of being delayed waiting for a request from the browser.

While current browser architectures do provide support for the polling of data through the use of scripting, these solutions can be unreliable. For example, if the recipient of a polling request becomes unavailable, an HTTP timeout will occur, causing a script error that typically results in a canceling of the polling request. Support for the various scripting languages can vary widely among the different browser clients and script versioning issues can be problematic. In addition, scripts can be used as a vehicle for introducing viruses into the browser and/or the client device on which the browser runs, leading some users to disable scripting support in their browsers.

The use of synchronous communication protocols through centralized sites such as EBAY and AMAZON for buying and selling goods and/or services also limits the freedom of individual buyers and sellers in terms of fees they pay, where they can shop and sell, and the methods they can use to advertise and locate the goods and services. Browser based buying and selling also limits users ability to obtain real-time information on the item that they are bidding on, considering for a purchase, or have purchased or won in an auction.

Accordingly, it can be preferable to use an asynchronous communications protocol, such as a publish/subscribe (“pub/sub”) protocol or a presence protocol, which is a type of pub/sub protocol, for online business transactions. Pub/sub protocols may be run on powerful servers operated by a commercial operation, they may be integrated into a seller's site, they may be provided by Internet service providers (ISPs) or companies like Yahoo, AOL, etc., for the use of their customers, or they may be run on devices with public Internet protocol (IP) addresses located in homes or small businesses.

Conventional applications or services built on asynchronous communications protocols, such as presence services, have their drawbacks as well. These applications typically require the use of their own proprietary application-specific client to support the service. For example, for a user to use an Instant Messaging (IM) service, the user must typically install a particular IM-specific client. Users typically cannot use a more generic client, such as a browser, to support presence-based service. Moreover, as the popularity of these asynchronous communications protocol-based applications or services continues to grow; the number of application-specific clients needed will grow proportionately.

In addition to these drawbacks, current presence-based applications and/or services typically do not support links within their tuples that refer to other presence tuples. Consequently, there typically is no system in place for establishing relationships among the tuples on various presence servers. Also, standard XML linking does not define relationship types that will be useful in a presence web. Moreover, current presence clients display a limited set of data, typically to one or more friends lists.

Some browser clients, such as KNOWNOW's LIVEBROWSER client, are capable of delivering notifications directly from a server to a browser with no polling. But these clients typically do not provide support for the browsing of presence servers (or pub/sub servers). Instead, these browser clients merely allow subscription based information to be presented in a web page. Typically, these browsers have accomplished this by providing an appropriate JavaScript library. But this technique can be particularly unreliable, as some browsers have scripting turned off.

Accordingly, there exist needs for methods, systems, and computer program products for conducting and/or facilitating business transactions using a pub/sub protocol

### SUMMARY

In one aspect of the subject matter disclosed herein, a method is disclosed for conducting a business transaction using a pub/sub protocol. Information about at least one of a sale or auction is received. The information is provided and updated using a pub/sub protocol. A request to take part in the sale/auction is sent and a response to the request is received.

In another aspect of the subject matter disclosed herein, a method is disclosed for conducting a business transaction using a pub/sub protocol. Information about at least one of a sale or auction is provided using a pub/sub protocol. A request to take part in the sale/auction is received.

In another aspect of the subject matter disclosed herein, a method for facilitating a business transaction using a pub/sub protocol. A request for information about at least one of a sale or auction is received from a remote endpoint and the requested information is provided to the remote endpoint. Updated information is provided to the remote endpoint using a pub/sub protocol.

In another aspect of the subject matter disclosed herein, a client is disclosed for conducting a business transaction using a pub/sub protocol. The client includes means for subscribing to information about at least one of a sale or auction using a pub/sub protocol and means for presenting the information about the at least one of a sale or auction and for receiving input regarding a request to take part in the sale/auction. The client also includes means for interfacing the means for subscribing to a communication network for subscribing to the information about the at least one of a sale or auction, for receiving information about the at least one of a sale or auction via the communication network and forwarding the received information to the means for presenting for presentation, and for sending the request to take part in the sale/auction to a remote endpoint via the communication network.

In another aspect of the subject matter disclosed herein, a client is disclosed for conducting a business transaction using a pub/sub protocol. The client includes a pub/sub agent configured for subscribing to information about at least one of a sale or auction using a pub/sub protocol and a user interface coupled to the pub/sub agent and configured to present the information about the at least one of a sale or auction and to receive input regarding a request to take part in the sale/auction. The client also includes a network interface coupled to a communication network, the protocol agent, and the user interface. The network interface is configured to allow the pub/sub agent to subscribe to the information about the at least one of a sale or auction via the communication network, is configured to receive information about the at least one of a sale or auction via the communication network and forward the received information to the user interface for presentation, and is configured to send the request to take part in the sale/auction to a remote endpoint via the communication network.

In another aspect of the subject matter disclosed herein, a client is disclosed for conducting a business transaction using a pub/sub protocol. The client includes a pub/sub agent configured for providing information about at least one of a sale or auction using a pub/sub protocol, a user interface coupled to the pub/sub agent and configured to present information about the at least one of a sale or auction, and a network interface coupled to a communication network, the protocol agent, and the user interface, wherein the network interface is configured to allow the pub/sub agent to publish the information about the at least one of a sale or auction via the communication network and is configured to receive a request to take part in the sale/auction from a remote endpoint via the communication network.

In another aspect of the subject matter disclosed herein, a router is disclosed for facilitating a business transaction using a pub/sub protocol. The server includes means for receiving a subscription to publish information about at least one of a sale or auction and for publishing the information using a pub/sub protocol and means for interfacing the means for receiving to a communication network for receiving the subscription and for publishing the information about the at least one of a sale or auction.

In another aspect of the subject matter disclosed herein, a server is disclosed for facilitating a business transaction using a pub/sub protocol. The server includes a pub/sub agent configured to receive a subscription to publish information about at least one of a sale or auction and to publish the information using a pub/sub protocol and a network interface coupled to a communication network and the pub/sub agent and configured to allow the pub/sub agent to receive the subscription via the communication network and to publish the information about the at least one of a sale or auction via the communication network.

In another aspect of the subject matter disclosed herein, a computer program product is disclosed. The computer program product includes computer executable instructions embodied in a computer-readable medium. The computer executable instructions are for performing steps including receiving information about at least one of a sale or auction, the information being provided and updated using a pub/sub protocol, sending a request to take part in the sale/auction, and receiving a response to the request.

In another aspect of the subject matter disclosed herein, a computer program product is disclosed. The computer program product includes computer executable instructions embodied in a computer-readable medium. The computer executable instructions are for performing steps including providing information about at least one of a sale or auction is using a pub/sub protocol and receiving a request to take part in the sale/auction.

In another aspect of the subject matter disclosed herein, a computer program product is disclosed. The computer program product includes computer executable instructions embodied in a computer-readable medium. The computer executable instructions are for performing steps including receiving a request for information about at least one of a sale or auction from a remote endpoint, providing the requested information to the remote endpoint, and providing updated information to the remote endpoint using a pub/sub protocol.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating an exemplary system for conducting a business transaction using a pub/sub protocol;

FIG. 2 is a block diagram illustrating an exemplary client included in a client device for conducting a business transaction using a pub/sub protocol;

FIG. 3 illustrates an exemplary browser;

FIG. 4 illustrates an exemplary tuple;

FIG. 5 is a block diagram illustrating a client configured as a selling application;

FIG. 6 is a block diagram illustrating a client configured as a s buying application;

FIG. 7 is a block diagram illustrating an arrangement for conducting a business transaction using a pub/sub protocol;

FIG. 8 is an exemplary user interface for a client with a buying application;

FIG. 9 is an exemplary user interface for a client with a selling application;

FIG. 10 is an exemplary user interface for a client that includes a page displayed in a browser window;

FIG. 11 is a block diagram illustrating exemplary buyer's tuples and their relationship;

FIG. 12 is a block diagram illustrating exemplary seller's tuples and their relationship;

FIG. 13 is a flow diagram illustrating a method for conducting a business transaction using a pub/sub protocol;

FIG. 14 is a flow diagram illustrating another method for conducting a business transaction using a pub/sub protocol;

FIG. 15 is a flow diagram illustrating a method for facilitating a business transaction using a pub/sub protocol;

FIG. 16 is flow diagram illustrating an exemplary process for conducting a business transaction using a pub/sub protocol;

FIG. 17 is flow diagram illustrating another exemplary process for conducting a business transaction using a pub/sub protocol;

FIG. 18 is flow diagram illustrating another exemplary process for conducting a business transaction using a pub/sub protocol;

FIG. 19 is a flow diagram illustrating another exemplary process for facilitating a business transaction at a presence server using a pub/sub protocol; and

FIG. 20 is a flow diagram illustrating another exemplary process for facilitating a business transaction involving the purchase of multiple items at a presence server using a pub/sub protocol.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

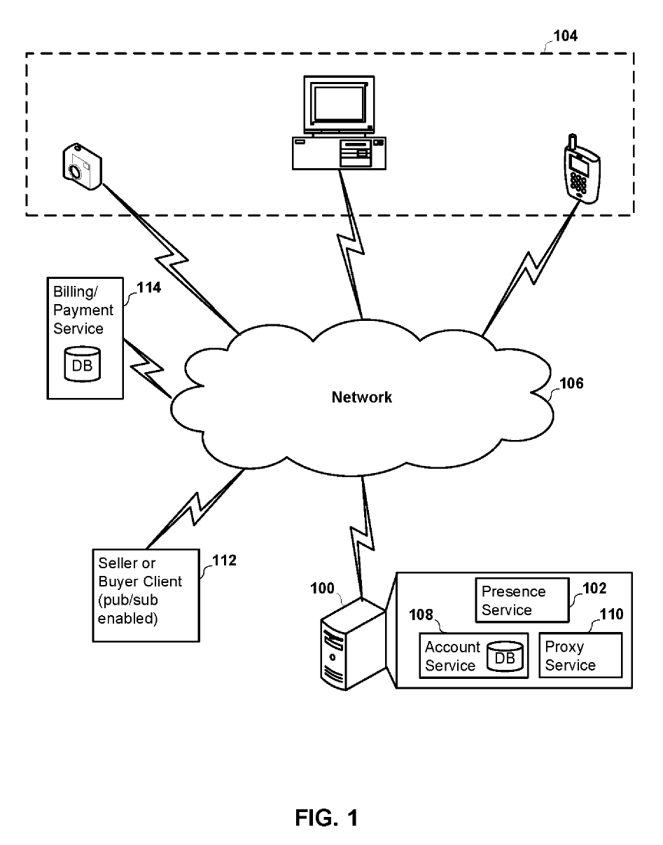

FIG. 1 is a block diagram illustrating an exemplary system for conducting a business transaction using a pub/sub protocol. For purposes of illustration, aspects of the subject matter described herein will be described with reference to the use of a presence protocol as an exemplary pub/sub protocol. The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society. Presence protocol is a type of pub/sub protocol that can be additionally defined generally as having an additional requirement not necessarily required of a pub/sub protocol. The additional presence-specific requirement is that a presence tuple contain a status element indicating a presence status.

The system illustrated in FIG. 1 includes a presence server 100 configured to receive, store, and distribute information via a presence service 102. The system further includes client devices 104 configured to exchange information with the presence server 100 via a network 106 using a presence protocol or other pub/sub protocol. The client devices 104 can include any of Personal Computers (PCs), Personal Digital Assistants (PDAs), network-enabled cameras, camera phones, mobile phones, and the like. Although depicted as a stand-alone server in FIG. 1, the presence server 100 can include several servers that together can function as the presence service 102. Moreover, the function of the presence server 100 can be incorporated, either in whole or in part, into any of the client devices 104 and server 100, and thus can be distributed throughout the network of elements shown. As such, the meaning of “presence server” used here does not strictly conform to the definition of a “server” included in RFC 2778 as being an indivisible unit of a presence service. Nevertheless, the presence server 100 and presence service 102 are closely linked to one another and can be considered to perform one and the same function. As used here, however, the presence server 100 can also include additional services, such as an account service 108 and proxy service 110, although these additional services need not be included in the server 100. It will be understood that these additional services can also be distributed across one or more servers or devices 102 interconnected via the network 106. The network 106 may be the Internet or any other communications network.

The system may also include a remote entity 112, such as a pub/sub-enabled (or presence-enabled) seller or buyer client. As will be described further below, the devices 104 includes a client to provide the necessary functionality for the devices 104 to conduct business transactions with at least one other party in a selling and/or buying capacity. The remote entity 112 represents the at least one other party and is arranged to conduct business transactions in a selling and/or buying capacity in cooperation with a client device 104. For example, remote entity 112 may be another client device similar to a client device 104. Accordingly, the clients described hereinbelow may be present in the the devices 104 and/or the remote entity 112.

The function of the presence server 100 can also be incorporated, either in whole or in part, into the remote entity 112. Using the exemplary system outlined in FIG. 1, a buyer or seller at a device 104 can conduct a business transaction with the remote endpoint 112 using a pub/sub protocol. The system also includes a billing/payment service 114 for managing financial aspects of business transactions.

The presence service model described in RFC 2778 describes two distinct users of a presence service, referred to as presence “clients”. The first of these clients, called a presentity (combining the terms “presence” and “entity”), provides presence information to be stored and distributed throughout the presence service. Presence information includes the status of a user of the presence service and may include additional information used by the service. This additional information can include, for example, the communication means and contact address of the user as described above. Presence information can be stored or maintained in any form for use by the presence service, but typically is organized into portions referred to as presence tuples. As will be understood by those skilled in the art, a tuple, in its broadest sense, is a data object containing one or more components. Thus, a presence tuple can include an identifier of a user and the user's status, contact address, or other information used by the presence service.

The second type of presence client is referred to as a “watcher”. Watchers receive presence information from the presence service. The presence model of RFC 2778 describes types of watchers, referred to as “subscribers” and “fetchers”. A subscriber requests notification from the presence service of a change in some presentity's presence information. The presence service establishes a subscription on behalf of the subscriber to a presentity's presence information, such that future changes in the presentity's presence information are “pushed” to the subscriber. In contrast, the fetcher class of watchers requests (or fetches) the current value of some presentity's presence information from the presence service. As such, the presence information can be said to be “pulled” from the presence service to the presentity. A special kind of fetcher, referred to as a “poller”, is defined in the model that fetches information on a regular (or polling) basis.

The presence service can also manage, store, and distribute presence information associated with watchers, as well as the watchers' activities in terms of the fetching or subscribing to the presence information of other presence clients using the presence service. This “watcher information” can be distributed to other watchers by the presence service using the same mechanisms that are available for distributing the presence information of presentities.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients to which these user agents interact, the presence and watcher user agents can be combined functionally as a single user agent having both the characteristics of the presence and watcher user agents. User agents can be implemented such that their functionality exists within the presence service, external to the presence service, or a combination or both internal and external to the presence service.

Most presence aware applications, such as Instant Messaging (IM), use presence services only to determine an application user's presence, status, and communication address. For example, IM applications do not use the presence service itself to deliver core application services and information, such as the instant messages themselves, to their users. More specifically, IM applications do not use the base presence protocol messages (or commands) to exchange instant message information, but instead rely on a separate and distinct instant message protocol (see, e.g., RFC 2778 and RFC 2779) to exchange this information.

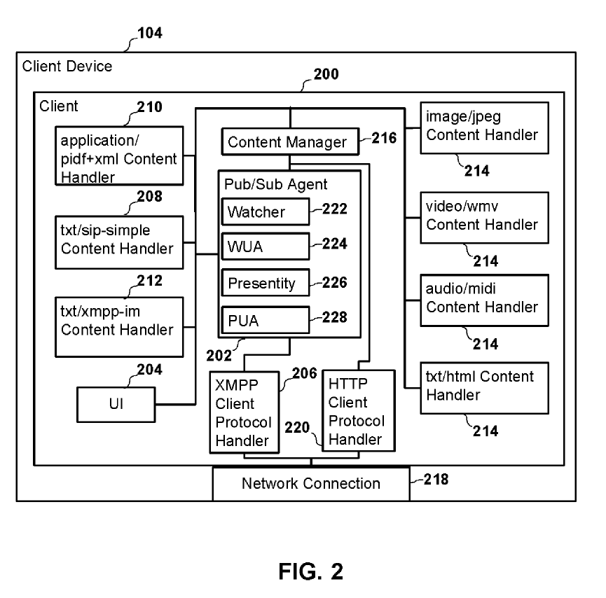

FIG. 2 is a block diagram illustrating an exemplary client included in a client device 104 for conducting a business transaction using a pub/sub protocol. According to this aspect, the client 200 can be a browser, similar to MICROSOFT'S INTERNET EXPLORER or MOZILLA FOUNDATION'S FIREFOX, but with additional pub/sub protocol functionality.

The client 200 includes means for subscribing to information about at least one of a sale or auction using a pub/sub protocol. For example, the client 200 can include a pub/sub agent 202 configured for subscribing to information about at least one of a sale or auction using a pub/sub protocol. For example, the pub/sub agent 202 may be configured to request a subscription to a tuple associated with an item for sale. The subscription request can be included in a message (or command) included in a pub/sub communications protocol. The communications protocol provides a set of standard rules and commands for data representation, signaling, authentication, and error detection required to send information over a communications channel of a network. The commands of a pub/sub protocol are structured such that a sender of information via the protocol, e.g., the client 200, need not wait for a response from a receiver, e.g., the server 100, after the receiver is notified of the information.

Generally, in a pub/sub protocol, senders of information (or publishers) post (or publish) messages with specific topics rather than sending messages to specific recipients. The pub/sub messaging system then selectively broadcasts the posted messages (through what are referred to as notify messages) to all interested parties, referred to as subscribers. The published information can be read simultaneously by any number of subscribing clients. To reiterate, aspects of the subject matter described herein employ a presence protocol as the pub/sub communications protocol. Nevertheless, the techniques described here can be performed using any pub/sub communications protocol.

It will be understood that some presence and pub/sub protocols do provide some level of acknowledgements for the publish and notify messages sent via the protocols. Notwithstanding this, these protocols are asynchronous as between a publisher and a subscriber. That is, using the publish, subscribe, and notify commands of these protocols, a publishing entity need not wait for a reply when a notification is sent to a subscribing entity, nor does the subscribing entity need to send a request (other than the initial subscribe message) to receive each notification.

In contrast, using a synchronous communications protocol, one entity in a communication network, e.g., the client 200, sends a request to another entity, then waits for a reply to the request before continuing processing/sending other requests to the entity or other entities in the network. Many of the more widely-known communications protocols in use today operate synchronously. For example, the HTTP protocol used in exchanging information via the World Wide Web (WWW) and in providing web services is a synchronous communications protocol.

The client 200 also includes means for presenting the information about the at least one of a sale or auction and for receiving input regarding a request to take part in the sale/auction. For example, the client 200 may include a user interface 204 coupled to the pub/sub agent and configured to present the information about the at least one of a sale or auction and to receive input regarding a request to take part in the sale/auction. As is commonly known in the art, the user interface 204 may include a presentation component, such as a display, speaker, and the like, and/or an input component, such as a keyboard, keypad, microphone, etc., for receiving input from a user.

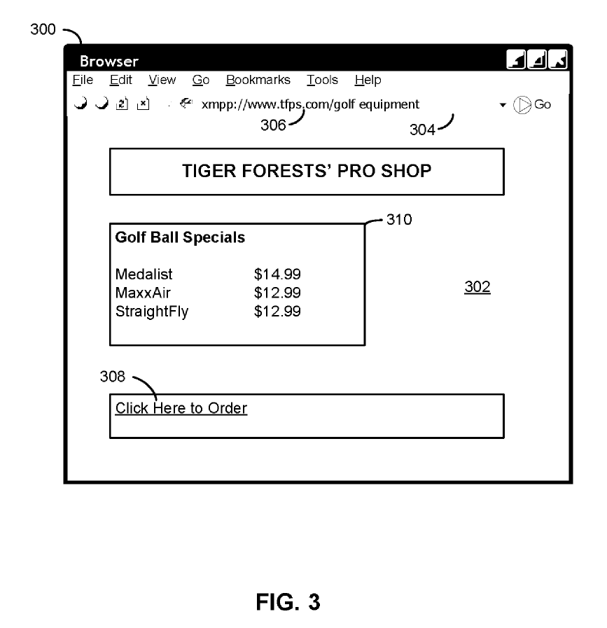

The user interface 204 may be configured to receive information about a sale or auction by receiving an identifier of a tuple associated with the sale or auction. For example, FIG. 3 illustrates an exemplary browser 300 having a control commonly referred to as a location bar 304. The location bar 304 can be used to enter text (e.g., using the “Go” button shown) corresponding to the identifier of the tuple associated with a sale or auction. In FIG. 3, the text “jep://www.tfps.com/golf equipment” 306 included in the location bar 304 is an identifier in the form of a Uniform Resource Identifier (URI) used to identify information associated with a sale or auction. Alternatively, the identifier can be a link, such as the hypertext link 308 having the text “Click Here to Order” displayed in a presentation space 302 of the browser a hundred. The link can be associated with a URI corresponding to another tuple related to the sale or auction. This other tuple could include a form object used to gather information from a user via the user interface 204 and to submit an order for merchandise. Note that while the URL header xmpp:// implies that the page is retrieved using extensible messaging and presence protocol (XMPP) as the protocol, the page may be a mixture of HTTP and XMPP retrieved content. For example, the page may be retrieved using HTTP and the display of items and prices may be retrieved using a pub/sub protocol. The link 308 may be either.

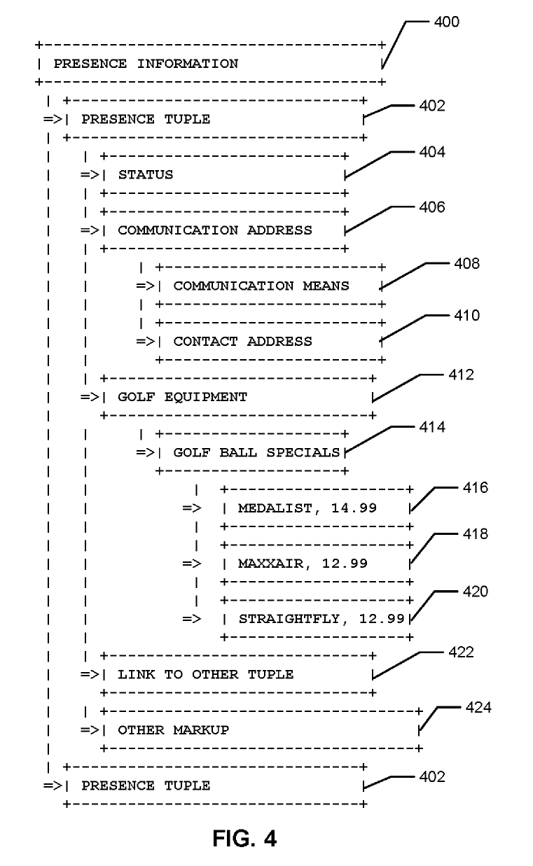

As used here, a “tuple” can be a representation that maps field names to certain values to indicate information related to the sale or auction and can include a link to other information related to the sale or auction. For example, FIG. 4 illustrates an exemplary tuple 402 associated with a sale of golf equipment. The information included in the tuple 402 can be exchanged via a presence service. As shown, the tuple 402 includes information stored in sub-tuples 412-420 related to a seller, and includes a sub-tuple 422 including information linking the tuple 402 to another tuple (not shown). The linking information included in the sub-tuple 422 can be associated with a navigable link, such as the hypertext link 308 shown in FIG. 3, to allow a user to navigate to the information included in the other tuple using the client 200.

FIG. 4 is a simplified representation of a seller's tuple. More extensive tuples from a buyer's and/or seller's perspective may be used that contain items for sale, such as a “catalog” or “auction” tuple, to allow items for sale to be easily located. Various other standards for tuples may be used to identify items, categories, and other information, some of which are described further below.

It should be noted, however, that the tuple illustrated in FIG. 4 is particularly appropriate when the use of a web server and a pub/sub server is combined such that the sale information is retrieved via a combination of HTTP and a pub/sub protocol.

Although a presence tuple is illustrated in FIG. 4, the tuple need not be a presence tuple, per se, nor need the tuple be exchanged via a presence service. Any tuple structure can be used with the techniques described here. Moreover, persons skilled in the art will understand that the data represented by a tuple may be stored in any format, including binary data or other proprietary data formats. As such, the tuple structure simply provides the external representation of the underlying data structure of the tuple information related to the network resource. For example, a well-formed HTML document is a tuple.

In addition to requesting a subscription to the tuple associated with the network resource, the pub/sub agent 202 is also configured to receive the information related to the sale or auction and the link based on the subscription to the tuple associated with the sale or auction. For example, the pub/sub agent 202 can receive a notification including the information stored in elements 412-422 of the presence tuple 402 based on the client's/browser's subscription to the tuple 402. The pub/sub agent 202 thus allows the client 200 to obtain information about a sale or auction via the network 106 using a pub/sub protocol. The pub/sub agent 202 allows the client 200 to subscribe to tuples including information and/or link to other tuples associated with a sale or auction, and to receive notifications including the information and the link pursuant to the outstanding subscription.

The client 200 may also include a pub/sub communications protocol stack component 206, such as an XMPP protocol stack. The pub/sub communications protocol stack component 206 is coupled to the pub/sub agent 202 and is configured to allow the pub/sub agent 202 to request the subscription to the tuple 402 associated with the sale or auction and to receive the information related to the sale or auction 412-420 using the pub/sub communications protocol. As understood by those skilled in the art, the pub/sub communications protocol stack component 206 is used to exchange information received or transmitted at the physical layer (e.g., the wire, air interface, or fiber optic cable) of the network 106, through the data link (e.g., ETHERNET, 802.11 WIFI), transport/network (e.g., TCP/IP) and application (e.g., XMPP) layers of the stack.

Although an XMPP protocol stack is shown, any appropriate protocol stack supporting a pub/sub protocol described above or other similar protocols may be employed. For example, a protocol stack supporting the SIMPLE communications protocol (not shown) can be coupled to a SIP-SIMPLE content handler component 208 for processing SIMPLE commands. Alternatively, any CPP compliant protocol stack as specified in RFC 3859 (not shown) can be coupled to the Presence Information Data Format (PIDF) content handler 210 for processing CPP commands. Similarly a generic pub/sub client protocol stack (not shown) could be coupled to an appropriate generic pub/sub content handler (not shown).

The client 200 may further include other content handlers configured to process information, e.g., the information included in the tuple 402, based on the type of the information. The type can be any of the number of available Multi-purpose Internet Mail Extensions (MIME) types. For example, the content handler 212 processes information having a “txt/xmpp-im” MIME type. Similarly, the content handlers 208 and 210 are configured to process information having “txt/sip-simple” and “application/pidf+xml” MIME types, respectively.

The client 200 can include one or more additional content handler components, such as the content handlers 214. Each additional content handler 214 can process the information related to the sale or auction and other content received by the client based on a respective type of the information and other content. The information type can again be any of the available MIME types, such as the “image/jpeg”, “video/wmv”, “audio/midi”, and “txt/html” types. In a related embodiment, the client 200 can also include a content manager component 216 coupled between the communications protocol stack component 206 and each of the content handler components 208-214. The content manager component 216 can be configured to route the information received via the communications protocol stack component 206 and a network connection 218 to at least one of the content handler components 208-214 based on the type (e.g., the MIME type) of the information and other content received.

The client 200 can also include a second communications protocol stack component, such as the HTTP client protocol stack 220, coupled to at least one of the additional content handler components 214. The second communications protocol stack component 220 can be configured to exchange information using a synchronous communications protocol, such as HTTP. The second communications protocol stack component 114 is used to exchange information received or transmitted at the physical layer (e.g., the wire, air interface, or fiber optic cable) of the network 116, through the data link (e.g., ETHERNET, 802.11 WIFI), transport/network (e.g., TCP/IP) and application (e.g., HTTP) layers of the stack. With such an arrangement, the client 200 can exchange information with conventional HTTP servers and can also exchange information with the presence server 100 using both synchronous (e.g., HTTP) and asynchronous (e.g., XMPP) protocols. Consequently, portions of the content shown in the browser 300 of FIG. 3 can be presented/updated using conventional HTTP signaling, while other portions can be presented/updated using asynchronous signaling (e.g., using XMPP). The novel arrangement allows both application designers and client users maximum flexibility in designing/utilizing their network services.

The user interface 204 can present at least some of the information 412-420 related to the sale or auction as content in a presentation space 302 of the client 200. For example, FIG. 3 illustrates exemplary content presentable using the client 200. As shown in the figure, the name of the online store “Tiger Forests' Pro Shop” can be presented in a title portion of the presentation space 302 of the client 200. The information included in elements 412-420 of the presence tuple 402 related to the price of golf balls available from the store can be presented in another portion 310 of the presentation space 302 of the browser. Also, the information included in the sub-tuple 422 linking the presence tuple 402 to perhaps another tuple (not shown) associated with a form object for ordering merchandise from the store can be presented as the link “Click Here to Order” 308 shown in the figure.

The user interface 204 or the presence server 100 can also be configured to convert at least some of the information 412-420 into a format usable by a principal associated with the client. Such a principal can be a person using the client 200 or can be another application or program configured to use the information and/or a link. Using a pub/sub protocol to exchange information between non-human principals (such as programs, services, or applications) can be an efficient arrangement for carrying out multi-party transactions. Agents can help to further improve the efficiencies in carrying out such transactions between non-human principals.

The content handler components 208-214 may also include parser components coupled to the pub/sub agent 202 and configured to receive the information 412-420 and parse and/or convert the information and/or link into a format usable by the user interface 204. For example, the information related to the sale or auction can be received in an XML document and the parser can be configured to use Extensible Stylesheet Language Transformations (XSLT) to transform the information related to the network resource and/or the link into a form suitable for display in the presentation space 302 of the client 102, as shown in FIG. 3. Using XSLT to transform and format XML into a presentable form is similar (at least in function) to using Cascading Style Sheets (CSS) to add styles (e.g., displaying text in a special font or color) to HyperText Markup Language (HTML) documents. This conversion can alternately be performed on the server 100 based on the client type and content types acceptable to the client as obtained in a subscription request.

According to another aspect, the browser includes a URI handler (not shown) configured to receive the identifier 306, 308 from the user interface component 204 in response to an entering of the identifier 306, 308 in a control component of the client, such as the location bar 304 included in the browser, or a selection of a link displayed in the presentation space 302 of the client 102, such as the link 308. Additionally, each content handler 210-214 may contain an input manager configured to receive form input entered via the user interface 204 corresponding to a form field element (not shown) associated with a form object that may be included in the information related to the sale or auction received via the communications protocol stacks 206 and 220.

The pub/sub agent 202 can include a watcher component 222 configured to request the subscription to the tuple 402 and an associated watcher user agent (WUA) component 224 configured to receive the identifier 306, 308 entered by a user (e.g. via an entry in the location bar 304 or via the link 308) using the user interface 204. The WUA 224 can pass the identifier 306, 308 to the watcher component 222, which then requests the subscription to the tuple 402. The watcher component 222 can send the request for a subscription to the tuple 402 to the presence server 100.

As described above, the pub/sub agent 202 is configured to receive the information 412-420 associated with a sale or auction based on the subscription to the tuple 402. For example, the watcher component 222 can also be configured to receive the notification including the information associated with a sale or auction from the presence server 100. When the subscription to the tuple 402 is received by the presence server 100, the presence server can send a notification including the information and the link associated with the tuple 402 to the client device 104. The watcher component 222 can receive this information via the pub/sub communications protocol stack 206, and the WUA 224 can then pass the information and the link to the appropriate content handler for processing prior to being passed to the Ul 204 for display.

The pub/sub agent 202 can also include a presentity component 226 and an associated presentity user agent (PUA) 228. The presentity/PUA 226, 228 can be configured to publish information to the presence server 100 related to the sale or auction. For example, the presentity/PUA 226, 228 can be configured to publish the information stored in elements 412-422 of the presence tuple 402 to the presence server 100 to provide information associated with the sale or auction to entities that are subscribed to the tuple 402. The presence server 100 can send this information to subscribers, such as the client 200, pursuant to their subscriptions to the presence tuple 402.

In addition, the presentity/PUA 226, 228 can be configured to publish the information stored in elements 412-422 of the presence tuple 402 to the presence server 100 for storage in another tuple (not shown) associated with a presence application configured to provide search services. Such a presence application can index the information included in its associated tuple (and any other linked tuples that may be defined) to provide search services to subscribing presence clients.

The presentity/PUA 226, 228 can also be configured to publish input received via the Ul 204 to at least one of the tuple 402, another tuple associated with the link, and a tuple associated with a form object (not shown) in response to the submission of a form. According to a related embodiment, the pub/sub agent 202 is configured to receive a notification, e.g., via the watcher/WUA 222, 224, including a result of the form submission based on the subscription to the tuple associated with the resource.

One skilled in this art will observe that the names of the components 222-228 of the exemplary pub/sub agent 202 correspond to the components of the presence model defined in RFC 2778 to Day et al., titled “A Model for Presence and Instant Messaging” (IETF, February 2000). It should be understood that the functions of the described components 222-228, namely the publish, notify, and subscribe functions, can be incorporated into any appropriate pub/sub or other asynchronous communications protocol.

As described above, the client 200 thus includes means for interfacing to a communication network for subscribing to the information about the at least one of a sale or auction, for receiving information about the at least one of a sale or auction via the communication network and forwarding the received information to the means for presenting for presentation, and for sending the request to take part in the sale/auction to a remote endpoint via the communication network. For example, the client 200 can include a network interface coupled to a communication network, the protocol agent, and the user interface, such as the client protocol handler 206 and network connection 218. The network interface is configured to allow the pub/sub agent 202 to subscribe to the information about the at least one of a sale or auction via the communication network, is configured to receive information about the at least one of a sale or auction via the communication network 106 and to forward the received information to the user interface 204 for presentation, and is configured to send a request to take part in the sale/auction to a remote endpoint via the communication network.

The client 200 may be configured to operate as a seller client, a buyer client, or both. For example, as a buyer client, the pub/sub agent 202 may receive one or more links using a pub sub protocol, with each link representing at least one tuple associated with the sale or auction. As a seller client, the pub/sub agent 202 may provide one or more links using a pub sub protocol, with each link representing at least one tuple associated with the sale or auction. Likewise, as a buyer client, the pub/sub agent 202 may generate a request to take part in the sale/auction and publish the request via the network interface using a pub/sub protocol. As a seller client, the pub/sub agent 202 may receive via a notification and process the request to take part in the sale/auction and act on it.

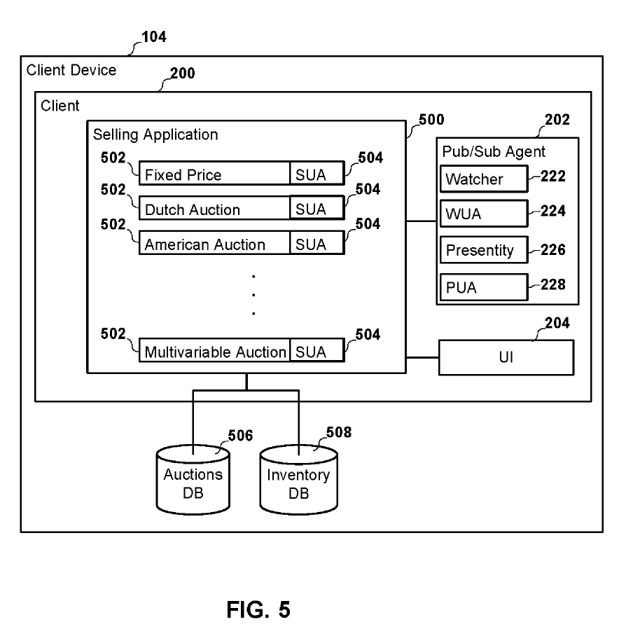

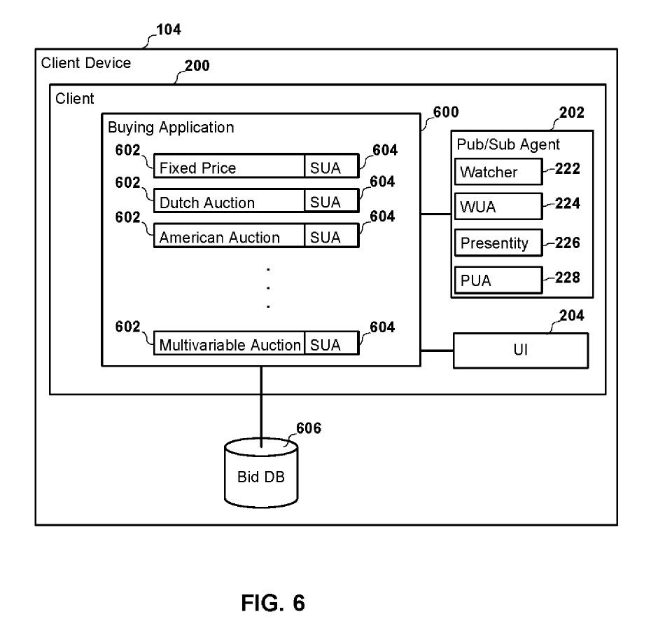

According to another aspect, the client 200 may not be directly associated with a browser as shown and described above with reference to FIG. 2. FIGS. 5 and 6 are block diagrams illustrating the client 200 configured as a selling application 500 and a buying application 600, respectively. Each application 500, 600 supports various types of business transactions via respective modules 502, 602. For example, the modules 502, 602 may be included for fixed-price sales, Dutch auction, American auction, multivariable auction, and the like. Each module 502, 602 may be integrated into the respective application 500, 600 or may be added as a plug-in module. Each module 502, 602 is associated with one or more service user agents (SUAs) 504, 604 associated with the respective business transaction service, e.g., fixed-price, Dutch auction, etc. A given SUA 504 translates communications between the module 502, 602 and the pub/sub agent 202. According to one aspect, an SUA 504, 604 can be used to translate communications associated with multiple services.

The client 200 in FIGS. 5 and 6 also includes the pub/sub agent 202 for subscribing to information about at least one of a sale or auction using a pub/sub protocol and to send the request to take part in the sale/auction to a remote endpoint via the communication network 106 in conjunction with the respective SUA 504, 604, and the user interface 204 configured to present the information about the at least one of a sale or auction and to receive input regarding a request to take part in the sale/auction. Although the pub/sub protocol handler 206 and the network connection 218 are omitted from FIGS. 5 and 6, it should be understood that these components are also associated with client 200 as described above.

The selling application 500 illustrated in FIG. 5 also accesses an auctions database 506 for managing information regarding items for auction, such as bids, current bid price, etc., and an inventory database 508 for managing inventory information. The auctions database 506 and the inventory database 508 may be included in the client device 104 or may be remotely located and accessed via a communications network.

The buying application 600 illustrated in FIG. 6 also accesses a bid database 606 for managing bids associated with auction, which may include bids submitted by a buyer via the client device 104 and/or bids submitted by other potential buyers. In one embodiment, at least a portion of the databases described for the client buying application 600 and the selling application 500 is stored at a pub/sub server where it may be accessed by other authorized clients.

It should be appreciated by one of ordinary skill in this art that the selling application 500 and the buying application 600 may be associated with the same client 200. It should further be appreciated that the selling application 500 and/or the buying application 600 may be associated with a server in communication with one or more client devices 104. For example, the applications 500, 600 may be associated with the presence server 100 and/or with a web server supporting other protocols such as HTTP, SMTP, FTP.

According to another aspect, the presence server 100 is configured for facilitating a business transaction using a pub/sub protocol. The presence server 100 includes means for receiving a subscription to published information about at least one of a sale or auction and to provide the information using a pub/sub protocol. For example, the presence server 100 may include a pub/sub agent configured to receive a subscription to provide information about at least one of a sale or auction and to provide the information using a pub/sub protocol. The presence server 100 also includes means for interfacing the means for receiving to a communication network for receiving the subscription and for providing the information about the at least one of a sale or auction. For example, the presence server 100 may include a network interface coupled to a communication network and the pub/sub agent and configured to allow the pub/sub agent to receive the subscription via the communication network and to provide the information about the at least one of a sale or auction via the communication network.

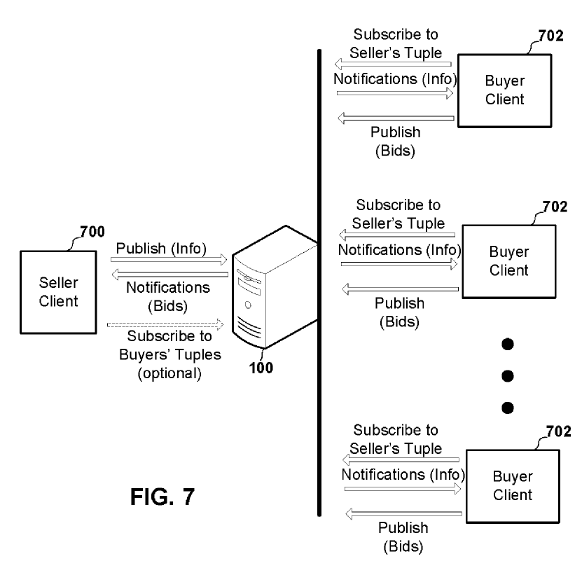

FIG. 7 is a block diagram illustrating an arrangement for conducting a business transaction using a pub/sub protocol. In FIG. 7, a seller client 700 publishes information about a sale or auction to the presence server 100. For example, the seller client 700 can publish information about the sale or auction to a tuple associated with a presence service on the presence server 100. One or more buyer clients 702 subscribe to the tuple to receive information regarding the sale or auction as notifications according to a pub/sub protocol, such as a presence protocol. As notifications are received by the buyer clients 702, each buyer client 702 may publish a bid to the seller's tuple associated with the auction/sale. Alternatively, each buyer client 702 may publish a bid to their own tuple and the seller client 700 receives a notification of each buyer's tuple through a subscription held by the seller client 700 or through the use of directed notifications to the seller client 700. As bids are received from the buyer clients 702 at the presence server 100, notifications may be sent to the other buyer clients 702 and/or the seller client 700 pursuant to their respective subscriptions and depending on the type of auction (silent or open). The seller client 700 may also publish updated information to the associated tuple as bids are received.

It should be appreciated that the seller client 700 and the buyer client 702 can both publish to the same tuple or can each publish to their own tuple. In addition, although only one presence server 100 is shown in FIG. 7, one of ordinary skill in this art should appreciate that the buyer client 702 and the seller client 700 can each be associated with separate presence servers. The presence servers in such a case may communicate with each other to exchange information, if necessary.

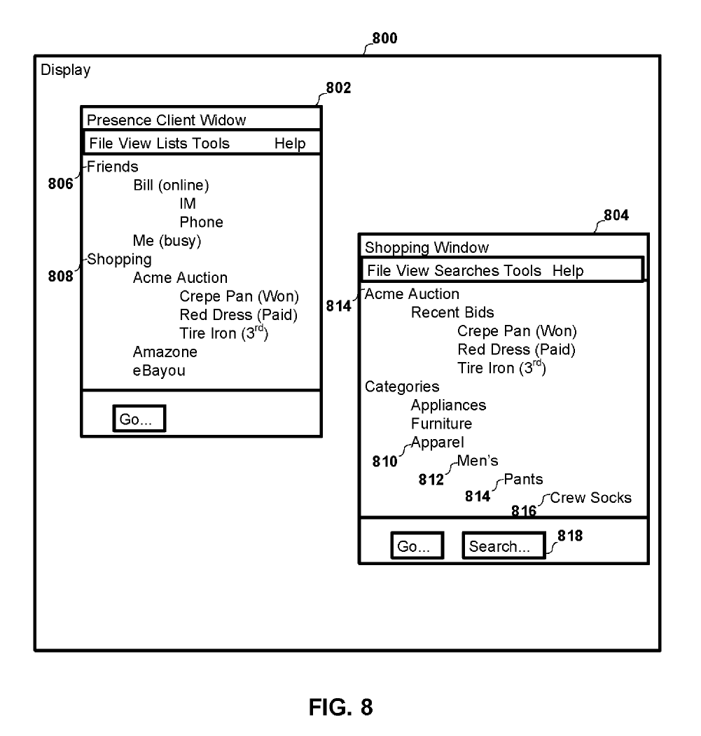

FIG. 8 is an exemplary user interface for the client 200 with a buying application 600. In FIG. 8, a display 800 includes a presence client window 802 in a shopping window 804. The presence client window 802 includes friend's presence information 806, similar to a buddy list in an IM application, and shopping information 808 providing information about sale or auction items that the buyer/user has subscribed to and their status, e.g., won, paid, etc. The shopping window 804 provides information about sale or auction items that a user/buyer may be interested in. The shopping window 804 may also include links 810 to information about the sale or auction items. The links 810 identify a tuple providing information according to a pub/sub protocol. Activating a link 810 may cause additional sub-links 812-816 to be displayed that correspond to other tuples or to sub-tuples. The shopping window 804 also includes a search function 818 to allow text-based searching through links to tuples. Each time a link is selected, a new subscription is placed for the tuple data that the link references. Once an item is located in the shopping window 804 by navigating through the links to tuples, a user may publish a bid to purchase the item, as described with reference to FIG. 7. Activating each link while navigating to the tuple may also generate a subscription to the tuple corresponding to the link, which may be for a category of items. Subscriptions may be terminated as items and/or categories are no longer presented. Once a user subscribes to an item, the item and its status is displayed in the presence client window 802. The shopping window 804 may also include information 814 about items that the buyer/user has subscribed to and their status.

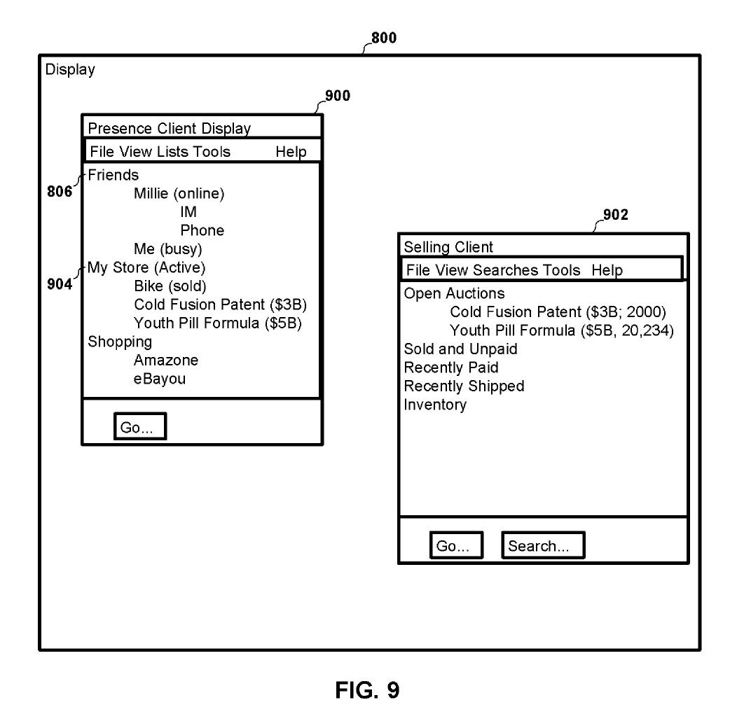

FIG. 9 is an exemplary user interface for the client 200 with a selling application 500. In FIG. 9, the display 800 includes a main presence client window 900 and a selling window 902. The main presence client window 900 once again includes friends' presence information 806. The main presence client window 900 also includes store information 904 providing information about sale or auction items that the seller/user has published and buyers have subscribed to, along with their status, e.g., sold, current bid price, etc. The selling window 804 provides information about all sale or auction items that the seller has published, along with information about inventory, payments, item status, and the like.

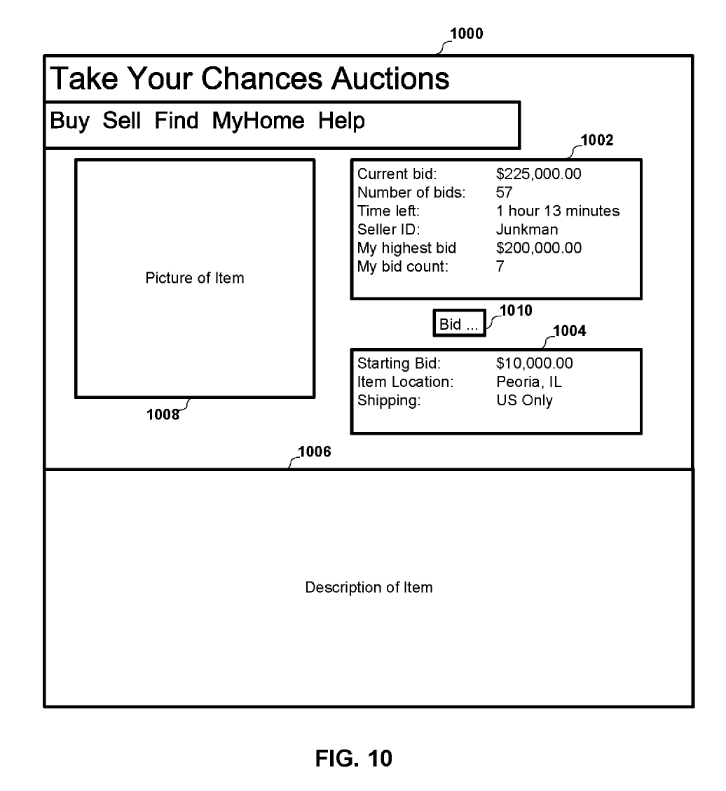

FIG. 10 is an exemplary user interface for the client 200 that includes a page displayed in a browser window 1000. The browser window 1000 includes content areas for the information 1002, the starting bid information 1004, the description of an item for sale or auction 1006, a picture of the item for sale or auction 1008, and a bid button 1010 for initiating a bid. Each content area 1002-1008 may be assigned to a corresponding content handler for pub/sub information. A web page can include an embedded pub/sub URI for each content area for use in retrieving the information and employing the appropriate content handler for processing the information.

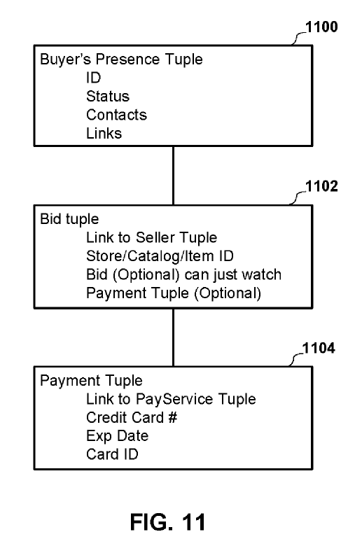

FIG. 11 is a block diagram illustrating exemplary buyer's tuples and their relationships. A buyer's presence tuple 1100 includes presence information such as the buyer's ID, the buyer's status, the buyer's contacts, and links to other presence-related tuples. Linked to the buyer's presence tuple 1100 is one or more bid tuples 1102 that may include a link to a seller's tuple; information about the items such as the item ID, store, and catalog; and information about the bid or sale. Alternatively, a buyer client can monitor the seller's tuple to obtain information about the bid or sale. The bid tuple 1102 also includes a link to a payment tuple 1104 that includes payment information for items purchased or won at auction. The payment tuple 1104 may include a link to a pay service tuple and credit card information. It should be understood that the buyer's tuples illustrated in FIG. 11 are exemplary and many other variations may be used that includes more or less information, tuples, and/or relationships between tuples.

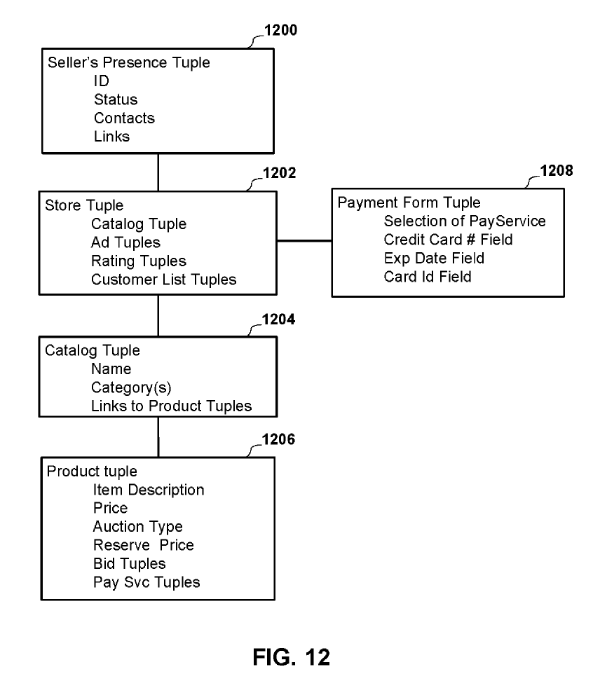

FIG. 12 is a block diagram illustrating exemplary seller's tuples and their relationship. A seller's presence tuple 1200 includes presence information such as the buyer's ID, the buyer's status, the buyer's contacts, and links to other presence-related tuples. Linked to the buyer's presence tuple 1100 is one or more store tuples 1202 that may include a catalog tuple with information about the store catalog; ad tuples with information about store ads; rating tuples with information about customer ratings for the store; and customer list tuples with information about the store's customers. The stored tuple 1202 may be linked to one or more catalog tuples 1204 each containing a categorized list of the products or services available, which includes names, categories, and links to specific product tuples. The catalog tuple 1204 is also linked to one or more product tuples 206 including specific information about various products. The product tuple information can include item descriptions, price, auction type, reserve price, bid tuples, and pay service tuples. The store tuple 1202 also includes a link to a payment tuple 208 that includes payment information for items or services sold. The payment tuple 1208 may include a link to a pay service tuple and credit card information. Once again, it should be understood that the seller's tuples illustrated in FIG. 12 are exemplary and many other variations may be used that includes more or less information, tuples, and/or relationships between tuples. For example, a shopping cart tuple may be included among the seller's tuples for maintaining information about multiple products for purchase by a given buyer.

It should be understood that the various components illustrated throughout the Figures represent logical components that are configured to perform the functionality described herein and may be implemented in software, hardware, or a combination of the two. Moreover, some or all of these logical components may be combined and some may be omitted altogether while still achieving the functionality described herein.

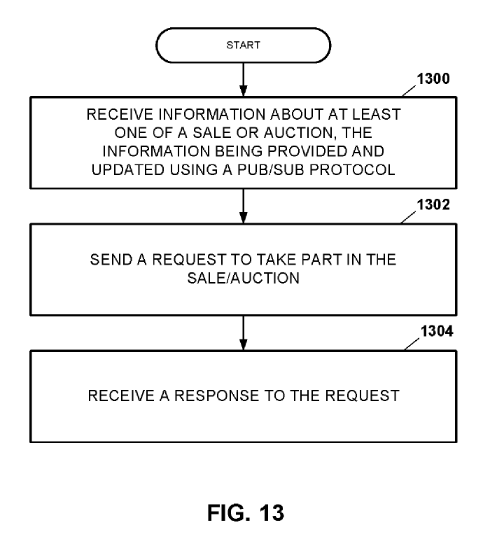

FIG. 13 is a flow diagram illustrating a method for conducting a business transaction using a pub/sub protocol. Information about at least one of a sale or auction is received at the client 200 in block 1300. Here, the client 200 may be a seller client 700 or a buyer client 702. The received information is provided and updated using a pub/sub protocol. The client 200 sends a request to take part in the sale/auction in block 1302. The client 200 receives a response to the request in block 1304.

Assuming the client 200 is a buyer client 702, the information received by the client 200 using a pub/sub protocol may include receiving a list of links, where each link represents at least one tuple associated with the sale or auction and/or tuple information about the sale or auction. This information may be received in a notify message received pursuant to a subscription. The request to take part in the sale/auction, such as a bid or offer to purchase an item, may also be sent using a pub/sub protocol. For example, a bid may be published to the presence server 100 by the buyer client 702 and sent as a notification message to the seller client 700. Alternatively, the request may be sent using other known protocols, such as HTTP. Similarly, the response to the request may be received at the buyer client 702 according to a pub/sub protocol (e.g., a notification message) or other known protocols.

Assuming the client 200 is a seller client 700, the information received by the client 200 using a pub/sub protocol may include receiving a bid or offer to purchase an item from a buyer client 702. This information may be received in a notify message received pursuant to a subscription. The request to take part in the sale/auction, such as an acceptance of the bid or offer to purchase the item, may also be sent using a pub/sub protocol. For example, an updated auction tuple may be published to the presence server 100 by the seller client 700 that includes the newly accepted bid. A corresponding notification message is sent to the buyer client 702. Alternatively, the request may be sent using other known protocols, such as HTTP. Similarly, the response to the request may be received at the seller client 700 according to a pub/sub protocol (e.g., a notification message) or other known protocols. The response to the request may be an order to complete the transaction or may be an updated bid.

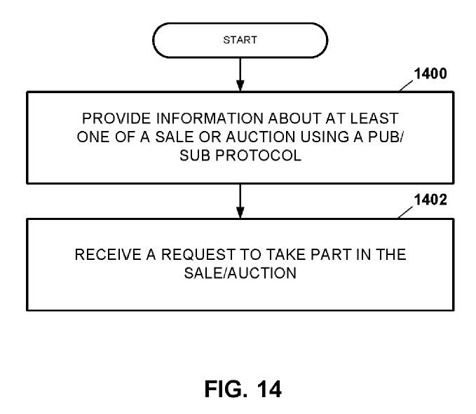

FIG. 14 is a flow diagram illustrating another method for conducting a business transaction using a pub/sub protocol. Information about at least one of a sale or auction is provided using a pub/sub protocol in block 1400. For example, from a seller perspective, the seller client 700 can publish to a sale/auction tuple on the presence server 100. From a buyer perspective, the buyer client 702 can publish a bid on an item or an offer to purchase an item to a bid/purchase tuple on the presence server 100. In either case, the publishing entity receives a request to take part in the sale/auction in block 1402. For example, the request can include a bid/offer to purchase from a buyer (in the seller perspective example) or can include an acceptance of the bid/offer to purchase from a seller (in the buyer perspective example). The request to take part in the sale/auction may be received via a pub/sub protocol or via another known protocol.

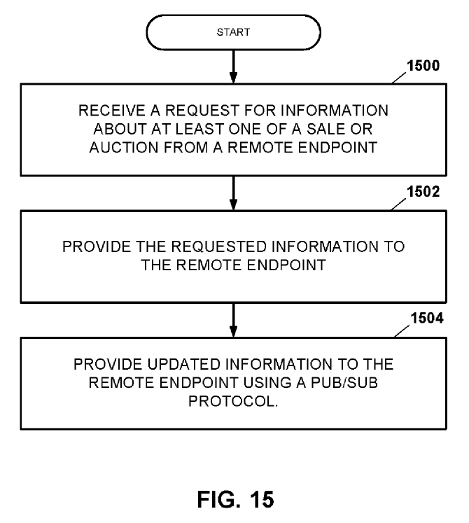

FIG. 15 is a flow diagram illustrating a method for facilitating a business transaction using a pub/sub protocol. In block 1500, the presence server 100 receives a request for information about at least one of a sale or auction from a remote endpoint, such as the client 200. Again, the client 200 can be either the buyer client 702 or the seller client 700. The presence server 100 provides the requested information to the remote endpoint in block 1502. The presence server 100 provides updated information to the remote endpoint using a pub/sub protocol in block 1504.

Again, as discussed above, the request for information about at least one of a sale or auction may include receiving a subscribe message to subscribe to receive tuple information about the sale or auction. The presence server 100 may provide the requested information to the remote endpoint by providing a notify message. The updated information may also be provided to the remote endpoint using a pub/sub protocol by providing a subsequent notify message to the remote endpoint.

It should be appreciated that the subject matter described herein should not be limited to scenarios where all traffic exchanged between the buyer client and seller client is exchanged according to a pub/sub protocol and/or via a pub/sub server. Some of the communications exchanged may follow any other known protocol. For example, a response to an order may be sent via email or some other mode of communication. In another example, a user may find and locate a store on the web using HTTP and navigate the web site using HTTP. Pub/sub protocol communications could be reserved for communications occurring after an item is located, such as for showing status, price, bids, inventory, expected delivery date, and the like in real-time. In this manner, HTTP and a pub/sub protocol can interoperate to provide the needed functionality.

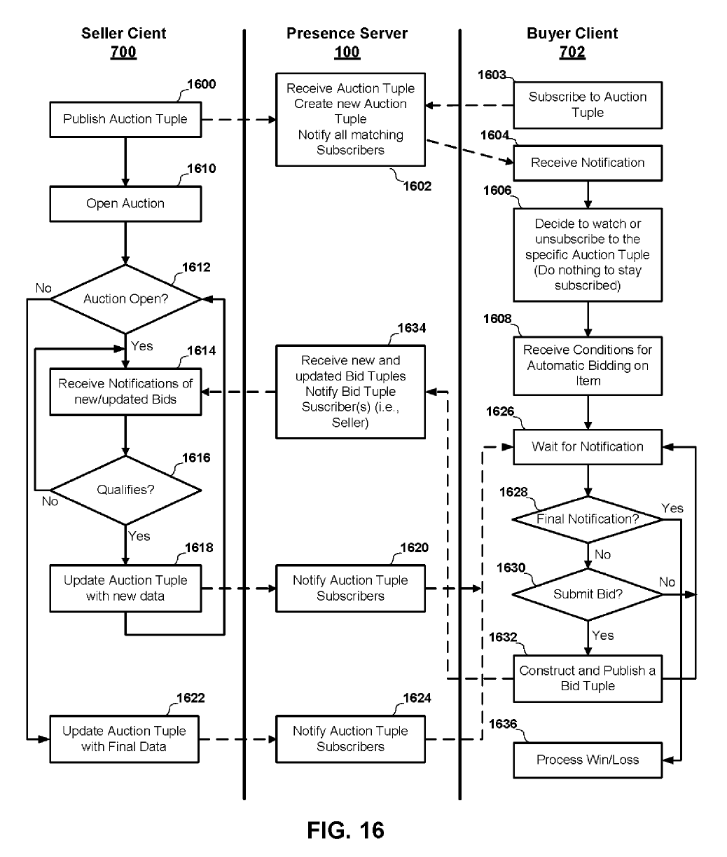

FIG. 16 is flow diagram illustrating an exemplary process for conducting a business transaction using a pub/sub protocol. In FIG. 16, an auction is taking place involving a seller client 700 and a buyer client 702 using a presence server 100 for at least some of the communications. In block 1600, the seller client 700 publishes an auction tuple to the presence server 100. In block 1602, the presence server 100 receives the auction tuple, creates a new auction tuple, and begins notifying subscribers to the auction/tuple. The buyer client 702 subscribes to the auction tuple in block 1603 and thus receives a notification with information about the auction tuple in block 1604. The buyer client 702 may at any time decide to unsubscribe to the tuple in block 1606. The buyer client 702 may also receive conditions for automatic bidding on the item for auction either via the notify message or via another message that does not necessarily follow a pub/sub protocol in block 1608, or from configuration data stored in an accessible storage device.

Meanwhile, the seller client 700 opens the auction in block 1610 and as long as the auction is determined to be open in block 1612, begins receiving notifications of new and updated bids from one or more buyer clients 702 via the presence server 100 in block 1614. The seller client 700, for each notification, determines whether a bid qualifies in block 1616 and updates the auction tuple with new data in block 1618 for each qualifying bid. Each time the auction tuple is updated, the seller client 700 notifies subscribers to the tuple via the presence server 100 in block 1620. If, in block 1612, the auction is determined to be closed, the auction tuple is updated with final data for the winning bid in block 1622 and a corresponding notify message is sent to subscribers in block 1624 via the presence server 100. The auction may be closed based on a timer elapsing or based on some other event occurring.

The buyer client 702, meanwhile, waits for notification in block 1626 and determines if a received notification is a final notification (auction closed) in block 1628. When a notification has been received, the buyer client 702 decides whether to submit a bid in block 1630 based on information contained in the received notification, such as current bid price, bid increment, and the like. If the buyer client 702 decides to submit a bid in block 1630, a bid is constructed and published to a bid tuple at the presence server 100 in block 1632. Here, as discussed above, the bid tuple could be specific to the buyer or to the seller. The presence server 100 receives the new/updated the tuple and notifies the seller client 700 of the new/updated bid. The seller client 700 may be notified using directed notify messages which are directed at the seller client 700 or may be notified pursuant to a subscription to the bid tuple. The subscription to the bid tuple may be placed at any time before or after a bid tuple is published. For example, the seller client 700 may become aware of a bid tuple via a directed notify using the initial bid. The seller client 700 may subscribe to the bid tuple upon receiving the initial bid, so that subsequent bids are received via normal notifications. In an alternate embodiment, the seller client 700 may receive a notification automatically from the presence server 100 when a subscription is received for the auction tuple or a tuple related to the auction tuple such as a catalog tuple.

If no bid is submitted in block 1630, control returns to block 1626 where the buyer client 702 waits for another notification. If, in block 1628 the buyer client 702 determines that a final notification has been received indicating that the auction is closed, the buyer client 702 processes the final notification in block 1636 based on whether the auction was won or lost.

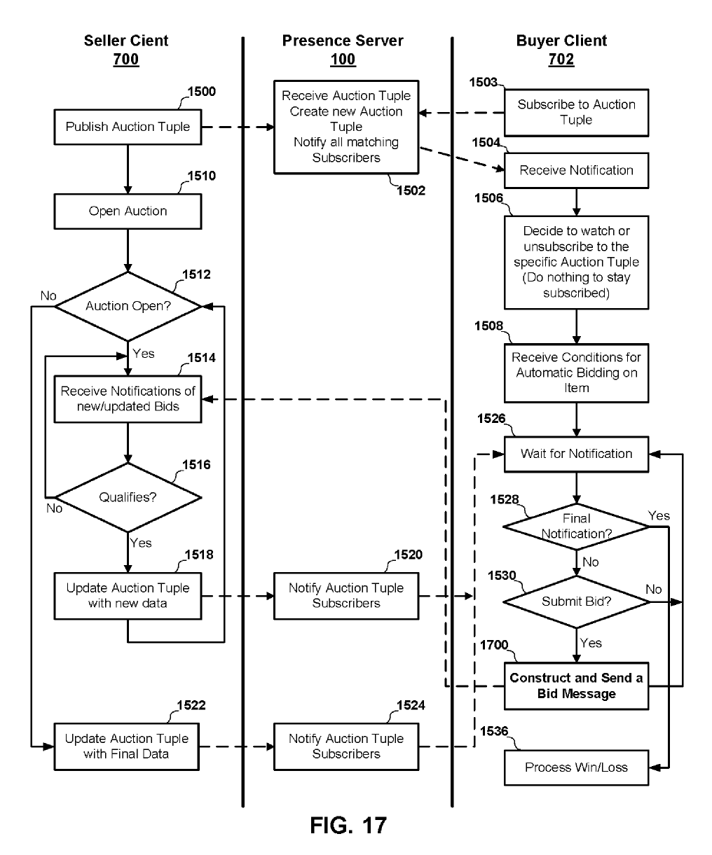

FIG. 17 is flow diagram illustrating another exemplary process for conducting a business transaction using a pub/sub protocol. In FIG. 17, an auction is taking place between a seller client 700 and a buyer client 702 using a presence server 100 as described with reference to FIG. 16. In the example of FIG. 17, however, the buyer client 702 does not construct and publish a bid message (as in block 1632 of FIG. 16), but instead constructs and sends a bid message directly to the seller client 700 in block 1700 without using a pub/sub protocol. For example, an e-mail message can be generated and sent to the seller client 700. Alternatively, any other known means of communication can be utilized to submit a bid to the seller client 700. As such, there is no bid tuple published to the presence server 100 as indicated in block 1634 of FIG. 16. The process is otherwise similar to that described with reference to FIG. 16.

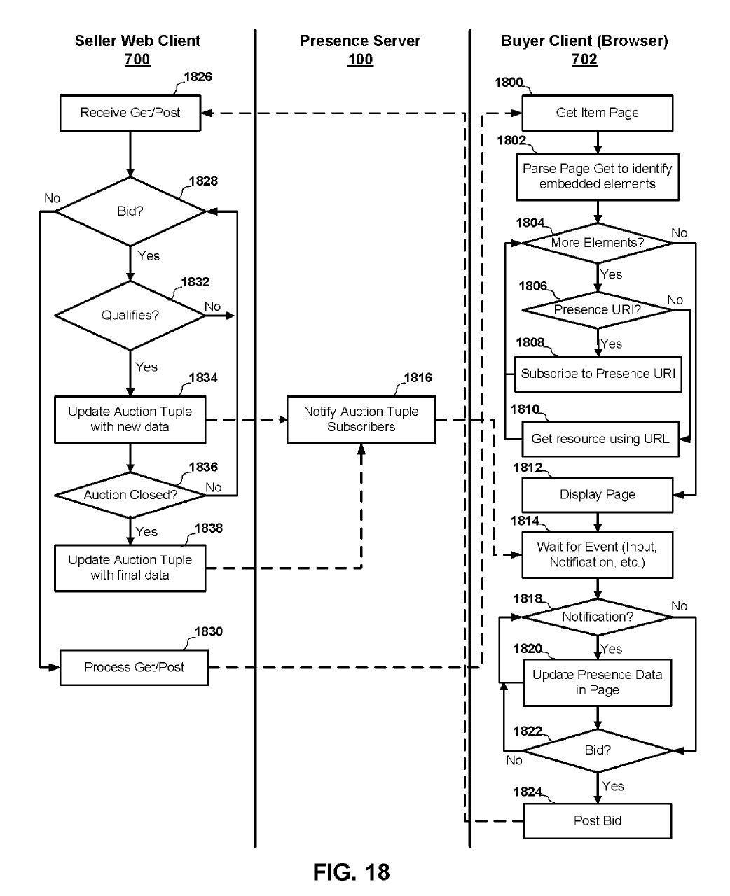

FIG. 18 is flow diagram illustrating another exemplary process for conducting a business transaction using a pub/sub protocol. In FIG. 18, an auction is taking place between a seller client 700 and a buyer client 702 using a presence server 100. In this example, the seller client 700 is a Web-enabled client, such as a web server, and the buyer client 702 is a browser. In block 1800, a page is received at the browser client 702 using, for example, an HTTP GET to command. The page is parsed in block 1802 to identify embedded elements and in block 1804 a check is made to determine whether all elements have been identified. The browser client 702 next determines in block 1806 whether one or more presence URIs are included among the identified elements. Each identified presence URI is subscribed to in block 1808. If no presence URIs are identified in block 1806, the non-presence resource is instead located in block 1810. Once all elements have been identified, as determined in block 1804, the page is finished being displayed on the browser client 702 in block 1812.

The browser client 702 waits for a notify message or user input corresponding to the subscribed to presence URIs in block 1814. For example, the browser client 702 may be notified of an auction tuple by presence server 100 in block 1816. Upon receiving a notification in block 1818, the browser client 702 updates the presence data in the displayed page in block 1820. Note that this occurs pursuant to the subscription according to a pub/sub protocol and without a request being generated by the browser client 702. Whether or not a notification is received, the browser client 702 may decide to initiate a bid in block 1822, which is posted to the seller Web client 700 in block 1824 according to the HTTP protocol POST command or GET command. In an alterate embodiment, the bid is sent using a publish command of a pub/sub protocol.

The seller Web client 700 receives the bid in block 1826 and determines whether the GET/POST information includes a bid in block 1828. In an alternate embodiment, the bid is received via a notification from the presence server 100. If no bid is included, the GET/POST is processed in block 1830 without updating the auction tuple. If, however, the get/post information includes a bid in block 1828, the seller Web client 700 determines whether the bid qualifies in block 1832 and updates the auction tuple with the new data in block 1834 when a qualifying bid is received. The updating of the auction tuple in block 1834 results in the notify generated in block 1816, as discussed above. When the seller Web client 700 determines that the auction is closed in block 1836, the auction tuple is updated with final data in block 1838. The auction may close after a predetermined period of time, for example, or as a result of some other triggering event or control.

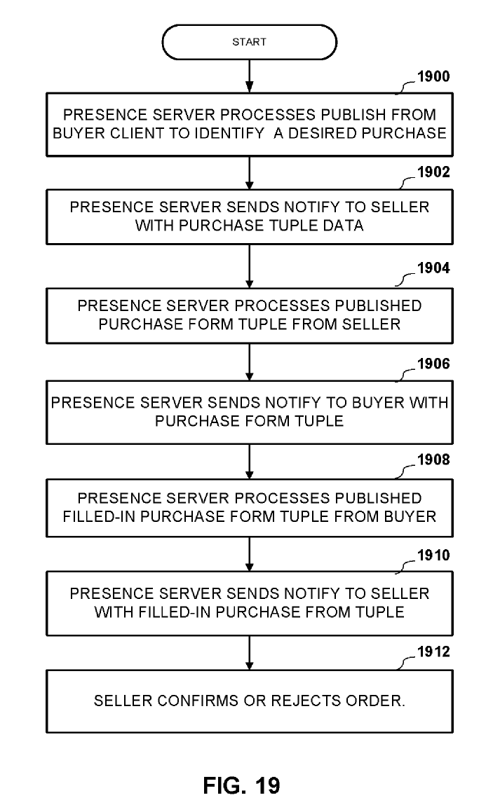

FIG. 19 is a flow diagram illustrating another exemplary process for facilitating a business transaction at a presence server using a pub/sub protocol. In FIG. 19, the presence server 100 processes a published purchase tuple from the buyer client 702 identifying one or more items for purchase in block 1900. The presence server 100 sends a notify message to the seller client 700 with purchase tuple data in block 1902. In block 1904, the presence server 100 processes a publish tuple with a purchase form received from the seller client 700. In block 1906, the presence server 100 sends the buyer client 702 a notify message with purchase form tuple. The presence server 100 processes a published, filled-in purchase form tuple from buyer client 702 in block 1908 and sends a notify to the seller client 700 with filled-in purchase form tuple in block 1910. The seller client 700 confirms or rejects the order in block 1912.

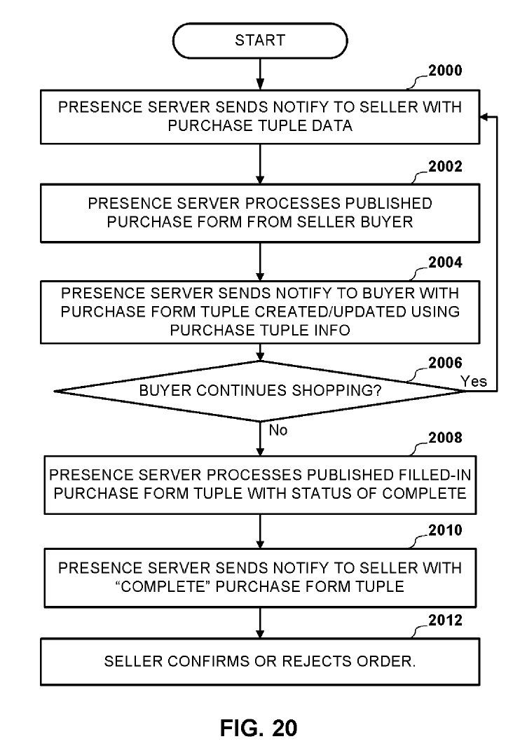

FIG. 20 is a flow diagram illustrating another exemplary process for facilitating a business transaction involving the purchase of multiple items at a presence server using a pub/sub protocol. In FIG. 20, after the presence server 100 processes a published purchase tuple from the buyer client 702, the presence server 100 sends a notify message to the seller client 700 with purchase tuple data in block 2000. In block 2002, the presence server 100 processes a publish tuple with a purchase form received from the seller client 700. In block 2004, the presence server 100 sends the buyer client 702 a notify message with purchase form tuple data. In block 2006, the buyer client 702 has decided whether to continue shopping. If the buyer client 702 continues shopping, then a notify message is sent to the seller client 700 with purchase tuple data for additional items. This process repeats until the buyer client 702 no longer continues shopping in block 2006, at which time the presence server 100 processes a published, filled-in purchased form tuple with a status of “complete” from the buyer client 702 in block 2008. The presence server 100 sends a notify message to the seller client 700 with complete purchase form tuple data in block 2010. The seller client 700 confirms or rejects the order in block 2012.

Although exemplary scenarios described herein use auctions as business transaction examples, it should be understood that the methods and systems described may also be used to conduct a fixed sale business transaction. It should be appreciated, that a fixed sale business transaction is merely a simplified version of an auction.

### ILLUSTRATIVE EXAMPLE

The following illustrative example uses a presence service, but it should be understood that other pub/sub communications protocols could be used to carry out the describe tasks.

An online shopper Bob wishes to purchase new golf balls. Bob brings up his buyer's client 200 and executes a search for sporting goods or golf retailers, for example in the shopping window 804 of FIG. 8. The client 200 presents a list of links to, and info from, the tuples/sub-tuples discovered using an indexing/search service. The indexing/search service can build a roster of relevant links, and the client 200 can display the status of each entity associated with a particular link in the roster. The search service can be represented by a presence tuple that is “owned” by the service itself or a service provider. Status for a particular retailer included in the displayed search results can reflect not only the retailer's operating state, but can also indicated the type of retailer, a customer satisfaction level, a size of the retailer's inventory, and the like, since status under RFC 2778 can be stored in an extendible sub-tuple.

Given that the search service is searching presence tuples built-up from specified vocabularies and ontologies, the service is able to perform more than just a keyword search. Instead, the service can accurately locate what the shopper Bob has requested based on the meaning of the various vocabularies and ontologies as well as the search terms. Requests and responses can be represented as tuple data as described in U.S. patent application Ser. No. 11/160,157, entitled “METHOD, SYSTEM, AND DATA STRUCTURE FOR PROVIDING A GENERAL REQUEST/RESPONSE MESSAGING PROTOCOL USING A PRESENCE PROTOCOL,” filed on Jun. 10, 2005, and assigned to the assignee of the present application. Tuple data can be exchanged using standard presence protocols.

Bob next selects Tiger Forests' Pro Shop (TFPS) since it has high ratings and a large inventory. The client 200 sends a subscribe command to retrieve the tuple info on TFPS. The tuple can include information or links to other tuples/sub-tuples containing information representing the various inventory categories. For example, with reference to FIG. 4, the sub-tuple “Golf Equipment” 412 and its associated sub-tuples 414-420 include the desired information regarding golf balls. Since the TFPS tuple represents an aggregate of a number of other tuples, the online shopper Bob is able to search the entire aggregation that makes up TFPS's tuple space.

Since an asynchronous protocol, such a presence protocol, is being used to browse the TFPS's tuple space, the client 200 is able to receive notifications of changes in TFPS's inventory and update the displayed data. If a price or inventory quantity changes, a user will see it on a display, without having to invoke an explicit refresh request for the data or having to using polling routines.

A merchandising application hosted on TFPS's server can be notified of Bob's subscription to their tuple information and can request a subscription to Bob's tuple information to be able to detect transaction requests from Bob.

Bob selects a “Golf Ball Specials” link and follows subsequent links until he locates a tuple for the package of golf balls he wants. Each time Bob selects a link that involves a new tuple, Bob's client 200 subscribes to the new tuple(s) and can unsubscribe to tuples that are no longer being displayed. Alternatively, the client 200 could maintain subscriptions for some time period, allowing Bob to revisit recently visited tuples in an efficient manner.

Bob then selects a “buy” link displayed on the presentation space of the client 200. This can result in a publish command being sent to the presence server 118 that creates a new order form tuple based, perhaps, on a template included in TFPS tuple. The new order form tuple can be returned to the client 200 (e.g., via a directed notify command or pursuant to an existing subscription). The client 200 can then display the order form information (not shown) including the item Bob wishes to purchase.

Bob can continue shopping through a link provided on the form or can indicate that he wishes to purchase twelve dozen golf balls. Bob presses the update button or link included on the order form (not shown). A publish request can be issued to process the form, which publishes the form data to Bob's tuple resulting in a notify command being sent to TFPS. TFPS can then update Bob's tuple in TFPS's tuple space including any calculated order information provided by their merchandising application. This update results in a notify command being sent to Bob's client 200, which can display the current shopping cart. Because TFPS is subscribed to Bob's order form tuple, the store can respond to each request made by Bob.

The order form tuple can next be updated to indicate it is now in a checkout state. Bob's order form tuple can include a link to Bob's tuple form which can include his shipping address, payment info, and the like. The order form tuple can be updated with this info via a publish command by TFPS, resulting in a notify to Bob's client 200 directed by the presence server 100. The status of the order form tuple can now be said to be in “confirm” state. Bob next enters his pin or password into the order form and presses a submit button to complete his order. This info is passed to the presence server 100 via a publish from the client 200 to Bob's tuple. The published information is received by TFPS via a notify command pursuant to its subscription to Bob's tuple information. After the presence server 100 verifies Bob's pin/password, the TFPS can update the status of the order to “accepted” via a publish command to the presence server 100. The presence server 100 can then update the information displayed on the client 200 via a notify command.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for conducting a business transaction using a pub/sub protocol, the method comprising:
receiving information about at least one of a sale or auction, wherein the information is provided and updated using a pub/sub protocol;
sending a request to take part in the sale/auction; and
receiving a response to the request.

2. The method of claim 1 wherein receiving information about at least one of a sale or auction includes receiving a list of links, each link representing at least one tuple associated with the sale or auction.

3. The method of claim 1 wherein receiving information about at least one of a sale or auction comprises:
sending a subscribe message to subscribe to receive tuple information about the sale or auction; and
receiving a notify message that includes the tuple information.

4. The method of claim 1 wherein the pub/sub protocol is a presence protocol.

5. The method of claim 1 wherein sending a request to take part in the sale/auction includes sending a request using a pub/sub protocol.

6. The method of claim 1 wherein receiving a response to the request includes receiving a response to the request using a pub/sub protocol.

7. A method for conducting a business transaction using a pub/sub protocol, the method comprising:
providing information about at least one of a sale or auction using a pub/sub protocol; and
receiving a request to take part in the sale/auction.

8. The method of claim 7 wherein providing information about at least one of a sale or auction using a pub/sub protocol includes publishing information about the at least one of a sale or auction to a presence server.

9. A method for facilitating a business transaction using a pub/sub protocol, the method comprising:
receiving a request for information about at least one of a sale or auction from a remote endpoint;
providing the requested information to the remote endpoint; and
providing updated information to the remote endpoint using a pub/sub protocol.

10. The method of claim 9 wherein receiving a request for information about at least one of a sale or auction includes receiving a subscribe message to subscribe to receive tuple information about the sale or auction.

11. The method of claim 10 wherein providing the requested information to the remote endpoint includes providing a notify message to the remote endpoint that includes the tuple information.

12. The method of claim 10 wherein providing updated information to the remote endpoint using a pub/sub protocol includes providing a notify message to the remote endpoint that includes updated tuple information.

13. The method of claim 9 wherein providing the requested information to the remote endpoint includes providing a list of links, each link representing at least one tuple associated with the sale or auction.

14. The method of claim 9 wherein the pub/sub protocol is a presence protocol.

15. A computer program product comprising computer executable instructions embodied in a computer-readable medium for performing steps comprising:
receiving information about at least one of a sale or auction, wherein the information is provided and updated using a pub/sub protocol;
sending a request to take part in the sale/auction; and
receiving a response to the request.

16. A computer program product comprising computer executable instructions embodied in a computer-readable medium for performing steps comprising:
providing information about at least one of a sale or auction using a pub/sub protocol; and
receiving a request to take part in the sale/auction.

17. A computer program product comprising computer executable instructions embodied in a computer-readable medium for performing steps comprising:
receiving a request for information about at least one of a sale or auction from a remote endpoint;
providing the requested information to the remote endpoint; and
providing updated information to the remote endpoint using a pub/sub protocol.

18. A client for conducting a business transaction using a pub/sub protocol, the client comprising:
means for subscribing to information about at least one of a sale or auction using a pub/sub protocol;
means for presenting the information about the at least one of a sale or auction and for receiving input regarding a request to take part in the sale/auction; and
means for interfacing the means for subscribing to a communication network for subscribing to the information about the at least one of a sale or auction, for receiving information about the at least one of a sale or auction via the communication network and forwarding the received information to the means for presenting for presentation, and for sending the request to take part in the sale/auction to a remote endpoint via the communication network.

19. A client for conducting a business transaction using a pub/sub protocol, the client comprising:
a pub/sub agent configured for subscribing to information about at least one of a sale or auction using a pub/sub protocol;
a user interface coupled to the pub/sub agent and configured to present the information about the at least one of a sale or auction and to receive input regarding a request to take part in the sale/auction; and
a network interface coupled to a communication network, the protocol agent, and the user interface, wherein the network interface is configured to allow the pub/sub agent to subscribe to the information about the at least one of a sale or auction via the communication network, is configured to receive information about the at least one of a sale or auction via the communication network and forward the received information to the user interface for presentation, and is configured to send the request to take part in the sale/auction to a remote endpoint via the communication network.

20. The client of claim 19 wherein the pub/sub agent is configured to receive a list of links, each link representing at least one tuple associated with the sale or auction.

21. The client of claim 19 wherein the pub/sub agent is configured to:
send a subscribe message to subscribe to receive tuple information about the sale or auction; and
receiving a notify message that includes the tuple information.

22. The client of claim 19 wherein the pub/sub protocol is a presence protocol.

23. The client of claim 19 wherein the request to take part in the sale/auction is generated by the pub/sub agent and sent via the network interface using a pub/sub protocol.

24. A client for conducting a business transaction using a pub/sub protocol, the client comprising:
a pub/sub agent configured for providing information about at least one of a sale or auction using a pub/sub protocol;
a user interface coupled to the pub/sub agent and configured to present information about the at least one of a sale or auction; and
a network interface coupled to a communication network, the protocol agent, and the user interface, wherein the network interface is configured to allow the pub/sub agent to publish the information about the at least one of a sale or auction via the communication network and is configured to receive a request to take part in the sale/auction from a remote endpoint via the communication network.

25. The client of claim 24 wherein the pub/sub agent is configured to provide information about the at least one of a sale or auction using a pub/sub protocol by publishing information about the at least one of a sale or auction to a presence server.

26. A server for facilitating a business transaction using a pub/sub protocol, the server comprising:
means for receiving a subscription to publish information about at least one of a sale or auction and to publish the information using a pub/sub protocol; and
means for interfacing the means for receiving to a communication network for receiving the subscription and for publishing the information about the at least one of a sale or auction.

27. A server for facilitating a business transaction using a pub/sub protocol, the server comprising:
a pub/sub agent configured to receive a subscription to publish information about at least one of a sale or auction and to publish the information using a pub/sub protocol; and
a network interface coupled to a communication network and the pub/sub agent and configured to allow the pub/sub agent to receive the subscription via the communication network and to publish the information about the at least one of a sale or auction via the communication network.

28. The server of claim 27 wherein the pub/sub agent is configured to receive a first subscribe message and to publish first tuple information about the sale or auction.

29. The server of claim 28 wherein the pub/sub agent is configured to receive a second subscribe message associated with the published first tuple information and to publish second tuple information about the sale or auction.

30. The server of claim 27 wherein the pub/sub agent is configured to publish a list of links, each link representing at least one tuple associated with the sale or auction.

31. The server of claim 27 wherein the pub/sub protocol is a presence protocol.
